(19) United States
(12) Patent Application Publication
(10) Pub. No.: US 2024/0191558 A1
(43) Pub. Date: Jun. 13, 2024

(54) MULTIPLE GLAZED UNIT OF A PRESSURIZED ENCLOSURE, HAVING A FILM OF ADHESIVE AND SOLAR-PROTECTION POLYMER MATERIAL

(71) Applicant: SAINT-GOBAIN GLASS FRANCE, COURBEVOIE (FR)

(72) Inventors: Adrien DUFFOUR, SAINT-CYR-EN-VAL (FR); Eric LINTINGRE, AVIGNON (FR)

(21) Appl. No.: 18/554,402

(22) PCT Filed: Mar. 21, 2022
(86) PCT No.: PCT/FR2022/050514

§ 371 Date: Oct. 6, 2023

(30) Foreign Application Priority Data
Apr. 9, 2021 (FR) 2103661

(51) Int. Cl. E06B 3/663; E06B 3/67; E06B 3/677

(52) U.S. Cl. CPC E06B 3/66342; E06B 3/67; E06B 3/677

(57) ABSTRACT

A multiple glazed unit for delimiting two spaces with a variable difference in pressure, includes at least one first outer slab, separated from a second slab by an air gap, by a sealant, at least one polymer film, a main surface of which is adhesive, and which includes a solar-protection layer or stack, a film being adhered to the main surface of the first slab facing the second slab and/or to one of the two main surfaces of the second slab or both and/or the first slab being a laminated glazed unit and a film being adhered to an internal main surface of the laminated structure.

The invention relates to a multiple glazed unit for delimiting two spaces with variable pressure independent of one another, in particular pressures that can differ more or less from one another. A typical example is the passenger cabin window of a commercial aircraft or a business jet which is subject to pressurization while the airplane can move at a relatively high altitude, and to lower pressure when on the ground.

This multiple glazed unit comprises a thick exterior slab which mechanically absorbs the different pressures inside and outside the enclosure, in particular by bending, and a thinner interior slab mounted parallel to the exterior slab at a certain distance therefrom, delimiting an intermediate air gap. The latter is connected to the interior atmosphere of the enclosure by a through-hole in the interior slab or the sealant of the multiple glazed unit. Furthermore, the interior slab is sized to replace the exterior slab if the latter breaks, in order to absorb the mechanical stresses due to pressure differences.

For a multiple glazed unit having an exterior slab and an interior slab, the corresponding four faces will be numbered from 1 to 4 starting from the outside. The face 1 F1 is in contact with the external atmosphere, the face 4 F4 with the volume of the enclosure.

An object of the invention is to provide a multiple glazed unit of the type described above having a solar-protection function. It is known, in particular, from document CA 2 763 423 A1 to coat a face of the multiple aircraft glazed unit with a stack of thin solar-protection layers, such as three-layer silver. Although this coating is not excluded by this document on face 2 F2, 3 F3 or 4 F4, the example of the document describes a coating on face 1 F1. It is also generally recognized that the positioning of a solar-protection coating in a glazed unit is favorable at the earliest possible stage of solar radiation, a positioning on face 1 F1 therefore being the best in satisfying this criterion. However, there remains a need to provide a multiple glazed unit with solar-protection function in a manner that is easier to implement, allowing easy adjustment of the degree of filtration of solar radiation.

This objective is achieved by the invention, which consequently has as its object a multiple glazed unit for delimiting two spaces with a variable difference in pressure, in particular an enclosure subjected to pressurization, comprising at least a first transparent slab intended to be in contact with the external atmosphere in the mounting position, and separated from a second transparent slab by an air gap, by means of a sealant wherein a peripheral part of the multiple glazed unit is embedded, characterized in that it comprises at least one film made of polymer material one main surface of which is functionalized for its adherence and maintenance with a substrate, and which comprises a layer or a stack of solar-protection layers, such polymer film being adhered to the main surface of the first slab facing the second slab and/or on one of the two main surfaces of the second slab or both and/or the first slab is a laminated glazed unit and such a polymer film being adhered to a main surface internal to the laminated structure of a constituent of the laminated glazed unit.

In accordance with the invention, a solar-control adhesive film is adhered to face 2 F2, face 3 F3, face 4 F4 of the multiple glazed unit, or in the case where the first slab is a laminated glazed unit, on a main face internal to the laminated structure (that is to say at a level of the thickness of the multiple intermediate glazed unit between face 1 F1 and face 2 F2). By virtue of the invention, the solar-control film(s) can easily be removed, replaced, in order to modify, adjust and adapt the degree of filtration of the solar radiation, the solar factor, or even in the event of damage to the film.

According to a first variant, the most preferred of the invention, a film of polymer material is adhered to the main surface of the second slab facing the first slab. The film is then not subject to mechanical bending and stresses of the first slab, which alone is subject to pressurization, contrary to the second slab. In addition, solar radiation encounters the solar-control layer or stack first, then the adhesive of the film, which is preferred.

In accordance with a second variant, to a lesser degree of preference than the first, a film of polymer material is adhered to the main surface of the second slab opposite the first slab. Like for the first variant, the film is not subject to mechanical bending and stresses of the first slab. However, with respect to the first variant, it is less favorable for the film to be downstream, farther from the solar radiation, which also first meets the adhesive of the film before the solar-protection layer or stack, which, again, is unfavorable. In addition, the film can be accessible, if necessary, to direct contact with the user and is therefore less well protected.

According to a third variant, a little less preferred than the second, the first slab is a laminated glazed unit and a film of polymer material being adhered to a main surface internal to the laminated structure, of a constituent of the laminated glazed unit. Although the solar-protection film is closer to the solar radiation than in the first, and even more the second variant, it is here subject to mechanical bending and stresses from the first laminated slab, subject to pressurization. The film is first bonded to a glass sheet or polymer material, then this sheet is laminated. In this third variant, it is preferred that said main surface internal to the laminated structure, of a constituent, be oriented toward the exterior surface of the multiple glazed unit consisting of the first slab and not toward the air gap and the second slab, so that the solar radiation first encounters the solar-control layer or stack before the adhesive layer of the film.

According to a fourth variant, also preferred to the third, a film of polymer material is adhered to the main surface of the first slab facing the second slab. The film undergoes the strong mechanical stresses of the first slab, and its adhesive layer receives solar radiation before its solar-protection coating.

These four variants are perfectly viable. However, it is not conceivable to bond the solar-protection film on face 1 F1 of the multiple glazed unit, that is to say in contact with the external atmosphere, due to aerodynamic stresses.

Preferably, the first slab has a thickness of between 1.5 and 20, preferably at most equal to 18, particularly preferably to 16 mm. These relatively large thicknesses can be necessary to withstand pressure differences on either side of the first slab, in particular in order to limit the bending thereof and the occurrence of loosening. This thickness is proportional to the main surface of the first slab.

Preferably, the second slab has a thickness of between 2 and 6 mm, preferably between 3 and 5 mm.

Preferably, the first slab is chosen from a sheet of polymer material such as poly(methyl methacrylate) (PMMA) in particular stretched, a sheet of glass such as soda-lime, aluminosilicate, borosilicate, optionally hardened, thermally tempered or chemically toughened, and a laminated glazed unit of at least two sheets of polymer and/or glass material bonded to one another by means of at least one adhesive interlayer such as polyvinyl butyral (PVB), thermoplastic polyurethane (TPU), or ethylene-vinyl acetate copolymer (EVA), silicone, crosslinked polyurethane or crosslinked polymethacrylates. Silicones can be used especially if a reinforced temperature resistance is desired. It is also possible to laminate plies of glass and/or polymer material by pouring a liquid resin between two substrates. These are resins (isocyanate+polyol) which polymerize to give a polymer interlayer of the crosslinked polyurethane type, or resins (methacrylates+thermal or UV catalyst) which polymerize to give a polymer interlayer of the cross-linked polymethacrylates type.

When the first slab is a sheet of polymer material, optionally a laminate of several sheets of polymer material, the total thickness of polymer material is between 7 and 20, and in order of increasing preference, 18 and 16 mm. When the first slab is a laminate of several glass sheets, optionally one glass sheet, the total thickness of glass is between 1.5 and 5 mm.

Preferably, the second slab is acrylic, such as made of stretched PMMA.

Preferably, the second slab or the sealant comprises a through-hole of small, controlled diameter, so that the air gap is at the same pressure as the volume delimited by the multiple glazed unit on the side opposite the first slab.

Preferably, a third constituent forms the main surface of the multiple glazed unit opposite the first slab, this third constituent being a sheet of polymer material separated from the second slab by another air gap. This third constituent is in contact with the interior volume of the passenger cabin, or equivalent. It is designated by the terms “dust cover” or “cover protection”. In a particularly preferred way, said third constituent is a polycarbonate (PC) or equivalent sheet and supports an electrochromic function. This function makes it possible to darken the window by electrically energizing the electrochromic layer.

An object of the invention is also the application of a multiple glazed unit as described above, as glazed unit of a volume subject to pressurization, in particular as aeronautical glazed unit, in particular as commercial aircraft or business jet glazed unit, most particularly as a passenger cabin window.

The invention is now shown by the following description of the appended figures in which

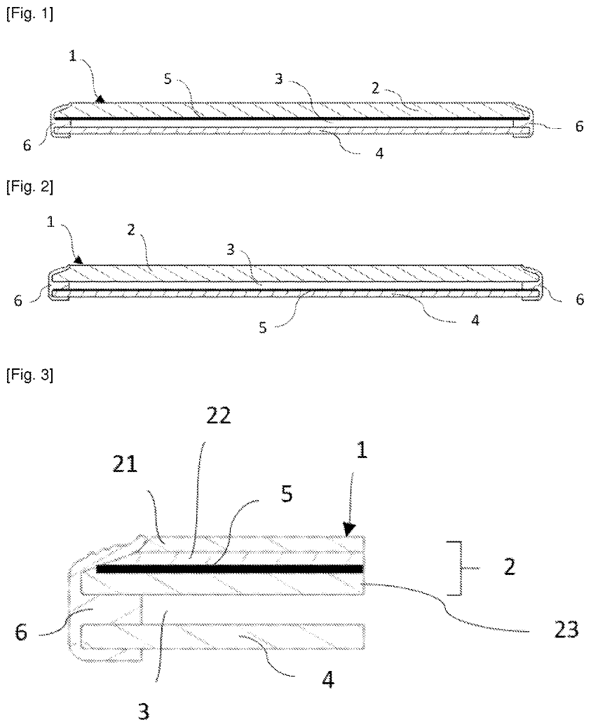

FIG. 1 is a cross-section of said fourth variant of the multiple glazed unit of the invention;

FIG. 2 is a cross-section of said first variant of the multiple glazed unit of the invention; and

FIG. 3 is a partial cross-section of said third variant of the multiple glazed unit of the invention.

With reference to FIG. 1, a window 1 of the commercial aircraft passenger cabin consists of a first stretched PMMA slab 2 with a thickness of between 9.5 and 11 mm, and a second stretched PMMA slab 4 that is 4 mm thick. The first slab 2 and the second slab 4 are embedded at their periphery in a silicone sealant 6, at a certain distance from one another constituting an air gap 3.

The thickness of the first slab 2 is a function of the value of its main surface, to allow it to withstand the pressurization of the cabin on the side of the second slab 4, by limiting its flexing in the event of a variation in the difference in pressures on its two main surfaces. A small through-hole (not shown) is provided in the second slab 4, so that the air gap 3 is at the cabin pressure on the side of the second slab 4, and that the first slab 2 assumes only the function of mechanical strength required by pressure differences on either side of the window 1.

A solar-control film 5 of poly(ethylene terephthalate) (PET) was provided on one face with an adhesive layer, by which the adhesive is applied to the main surface of the first slab 2 facing the second slab 4. The film 5 is provided with a stack of thin solar-protection layers as described in particular in document U.S. Pat. No. 2,018,362 395 A1.

The window 1 of FIG. 2 differs from that of FIG. 1 in that the film 5 is bonded to the main surface of the second slab 4 facing the first slab 2. Although according to FIG. 2, the solar-protection stack of the film 5 is further from the solar radiation source than in FIG. 1, it is preferred since, contrary to the latter, its support, the second slab 4, is not subject to any mechanical stress resulting from the cabin pressurization (contrary to the first slab 2), and moreover, solar radiation first encounters the solar-protection stack of the film before its layer of adhesive, which promotes the durability of the film 5.

With reference to FIG. 3, the first slab 2 consists of a first exterior sheet 21 of laminated stretched PMMA laminated to a second sheet 23 internal to the multiple glazed unit 1 of stretched PMMA, by means of an adhesive interlayer 22 of thermoplastic polyurethane (TPU). The solar-protection film 5 is bonded to the sheet 23 before lamination. According to this embodiment, the solar-protection stack is further upstream relative to the solar radiation source than in the embodiments of FIGS. 1 and 2, and solar radiation does indeed encounter the solar-protection stack of the film 5 before its layer of adhesive as in FIG. 2. Nevertheless, the embodiment represented by the latter is preferred since the film 5 of FIG. 3 is made vulnerable due to the mechanical stresses of the first slab 2, particularly of the second sheet 23 and of the adhesive interlayer 22 layer, mechanical stresses due to the cabin pressurization.

1. A multiple glazed unit for delimiting two spaces with variable difference in pressure, comprising at least one transparent first slab intended to be in contact with the external atmosphere in a mounting position of the multiple glazed unit, and separated from a second transparent slab by an air gap, by a sealant, wherein a peripheral part of the multiple glazed unit is embedded, wherein the multiple glazed unit comprises at least one film of polymer material having a main surface which is functionalized for its adherence and holding with a substrate, and which comprises a layer or a stack of solar-protection layers, said at least one film of polymer material being adhered to a main surface of the first slab facing the second slab and/or on one of the two main surfaces of the second slab or both and/or the first slab is a laminated glazed unit and said at least one film of polymer material is adhered to a main surface internal to a laminated structure of a constituent of the laminated glazed unit.

2. The multiple glazed unit according to claim 1, wherein the at least one film of polymer material is adhered to the main surface of the second slab facing the first slab.

3. The multiple glazed unit according to claim 1, wherein the at least one film of polymer material is adhered to the main surface of the second slab opposite the first slab.

4. The multiple glazed unit according to claim 1, wherein the first slab is a laminated glazed unit and the at least one film of polymer material is adhered to a main surface internal to the laminated structure, of the constituent of the laminated glazed unit.

5. The multiple glazed unit according to claim 4, wherein said main surface internal to the laminated structure, of a constituent is oriented toward an exterior surface of the multiple glazed unit consisting of the first slab and not toward the air gap and the second slab.

6. The multiple glazed unit according to claim 1, wherein the at least one film of polymer material is adhered to the main surface of the first slab facing the second slab.

7. The multiple glazed unit according to claim 1, wherein the first slab has a thickness of between 1.5 and 20 mm.

8. The multiple glazed unit according to claim 1, wherein the second slab has a thickness of between 2 and 6 mm.

9. The multiple glazed unit according to claim 1, wherein the first slab is chosen from a sheet of polymer material, a sheet of glass, optionally hardened, thermally tempered or chemically toughened, and a laminated glazed unit of at least two sheets of polymer and/or glass material bonded to one another by at least one adhesive interlayer.

10. The multiple glazed unit according to claim 1, wherein the second slab is acrylic.

11. The multiple glazed unit according to claim 1, wherein the second slab or the sealant comprises a through-hole of small, controlled diameter, so that the air gap is at the same pressure as the volume delimited by the multiple glazed unit on the side opposite the first slab.

12. The multiple glazed unit according to claim 1, comprising a third constituent that forms the main surface thereof opposite the first slab, said third constituent being a sheet of polymer material separated from the second slab by another air gap.

13. The multiple glazed unit according to claim 12, wherein said third constituent is a polycarbonate or equivalent sheet and supports an electrochromic function.

14. A method comprising providing a multiple glazed unit according to claim 1, as a glazed unit of a volume subject to pressurization.

15. The method according to claim 14, wherein the glazed unit is an aeronautical glazed unit.

16. The method according to claim 15, wherein the glazed unit is a passenger cabin window.

17. The multiple glazing unit according to claim 1, wherein the multiple glazed unit is for delimiting an enclosure subject to pressurization.

18. The multiple glazed unit according to claim 7, wherein the first slab has a thickness of at most equal to 18.

19. The multiple glazed unit according to claim 8, wherein the second slab has a thickness of between 3 and 5 mm.

20. The multiple glazed unit according to claim 9, wherein the polymer material is a poly(methyl methacrylate) (PMMA), the sheet of glass is a sheet of soda-lime, aluminosilicate, borosilicate, and the at least one adhesive interlayer is polyvinyl butyral (PVB), thermoplastic polyurethane (TPU), or ethylene-vinyl acetate (EVA) copolymer, silicone, crosslinked polyurethane or crosslinked polymethacrylates.
